(19) United States
(12) Patent Application Publication
(10) Pub. No.: US 2025/0079644 A1
(43) Pub. Date: Mar. 6, 2025

(54) ELECTRICAL CONNECTION SYSTEM AND ELECTRICAL CONNECTION METHOD

(71) Applicant: Ford Global Technologies, LLC, Dearborn, MI (US)

(72) Inventors: Ryan Douglas Matulich, Farmington, MI (US); Joseph B. Fricano, Canton, MI (US); Karen Siler, Commerce Twp., MI (US); Antony George Schepak, Howell, MI (US)

(21) Appl. No.: 18/461,745

(22) Filed: Sep. 6, 2023

(51) Int. Cl. H01M 50/507; B60L 50/60; B60L 50/64; H01M 50/291; H01M 50/516

(52) U.S. Cl. CPC H01M 50/507; B60L 50/64; B60L 50/66; H01M 50/291; H01M 50/516; H01M 2220/20

(57) ABSTRACT

An electrical connection system for a traction battery pack includes a clamping electrical contact having a first flange and a second flange, a clamped electrical contact, and a mechanical fastener that is secured to clamp the clamped electrical contact between the first flange of the clamping electrical contact and the second flange of the clamping electrical contact.

### TECHNICAL FIELD

This disclosure relates generally to electrical connection systems for use in a traction battery pack.

### BACKGROUND

A traction battery pack of an electrified vehicle can include groups of battery cells arranged in one or more cell stacks. The traction battery pack can include electrical connection systems that connect components of the traction battery pack. Electrical connection systems can also be used to connect components of the traction battery pack to components outside the traction battery pack.

### SUMMARY

In some aspects, the techniques described herein relate to an electrical connection system for a traction battery pack, including: a clamping electrical contact having a first flange and a second flange; a clamped electrical contact; and a mechanical fastener that is secured to clamp the clamped electrical contact between the first flange of the clamping electrical contact and the second flange of the clamping electrical contact.

In some aspects, the techniques described herein relate to an electrical connection system, wherein the clamping electrical contact extends from a first busbar, and the clamped electrical contact extends from a second busbar.

In some aspects, the techniques described herein relate to an electrical connection system, wherein the first busbar is electrically connected to a first battery, and the second busbar is electrically connected to a second battery.

In some aspects, the techniques described herein relate to an electrical connection system, wherein the first battery is within a first cell stack and the second battery is within a different, second cell stack.

In some aspects, the techniques described herein relate to an electrical connection system, wherein the clamping electrical contact is C-shaped.

In some aspects, the techniques described herein relate to an electrical connection system, wherein, when the mechanical fastener is secured, the mechanical fastener extends through an aperture in the first flange, and aperture in the second flange, and an aperture in the clamped electrical contact.

In some aspects, the techniques described herein relate to an electrical connection system, wherein the aperture in the clamped electrical contact is a slot that opens to an outer side of the clamped electrical contact.

In some aspects, the techniques described herein relate to an electrical connection system, wherein the slot is tapered moving toward the outer side of the clamped electrical contact.

In some aspects, the techniques described herein relate to an electrical connection system, further including a weld nut secured to the second flange, wherein, when the mechanical fastener is secured, the mechanical fastener threadably engages the weld nut.

In some aspects, the techniques described herein relate to an electrical connection system, wherein the clamped electrical contact and the clamping electrical contact are within a traction battery pack.

In some aspects, the techniques described herein relate to a method of electrically connecting components, including: positioning a clamped electrical contact between a first flange of a clamping electrical contact and a second flange of the clamping electrical contact; securing a mechanical fastener; and during the securing, clamping a clamped electrical contact between a first flange of the clamping electrical contact and a second flange of the clamping electrical contact.

In some aspects, the techniques described herein relate to a method, wherein, during the securing, the mechanical fastener extends through an aperture in the first flange, and aperture in the second flange, and an aperture in the clamped electrical contact.

In some aspects, the techniques described herein relate to a method, wherein the aperture in the clamped electrical contact is a slot that opens to an outer side of the clamped electrical contact.

In some aspects, the techniques described herein relate to a method, wherein the slot is flared moving toward an outer side of the clamped electrical contact.

In some aspects, the techniques described herein relate to a method, further including a weld nut secured to the second flange, wherein, when the mechanical fastener is secured, the mechanical fastener threadably engages the weld nut.

In some aspects, the techniques described herein relate to a method, wherein the clamping electrical contact extends from a first busbar, and the clamped electrical contact extends from a second busbar.

In some aspects, the techniques described herein relate to a method, wherein the first busbar is electrically connected to a first battery, and the second busbar is electrically connected to a second battery.

In some aspects, the techniques described herein relate to a method, wherein the first battery is within a first cell stack and the second battery is within a different, second cell stack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a battery cell from the battery pack of FIG. 2.

FIG. 4A illustrates a top view of Area 1 in FIG. 2 showing an electrical connection system according to an exemplary aspect of the present disclosure prior to securing a clamping electrical contact of the system to a clamped electrical contact of the system.

FIG. 4B illustrates a side view of the electrical connection system in FIG. 4A.

FIG. 5 illustrates a perspective view of the clamping electrical contact from the electrical connection system of FIGS. 4A and 4B.

FIG. 6 illustrates a perspective view of the clamped electrical contact from the electrical connection system of FIGS. 4A and 4B.

FIG. 7A illustrates the top view of FIG. 4A after securing the clamped electrical contact with the clamping electrical contact.

FIG. 7B illustrates a side view of the electrical connection system in FIG. 7A.

### DETAILED DESCRIPTION

This disclosure details exemplary electrical connection systems that electrically connect components within a traction battery pack. The electrical connection systems can help to accommodate for component alignments, build tolerances, etc. The electrical connection systems can facilitate service.

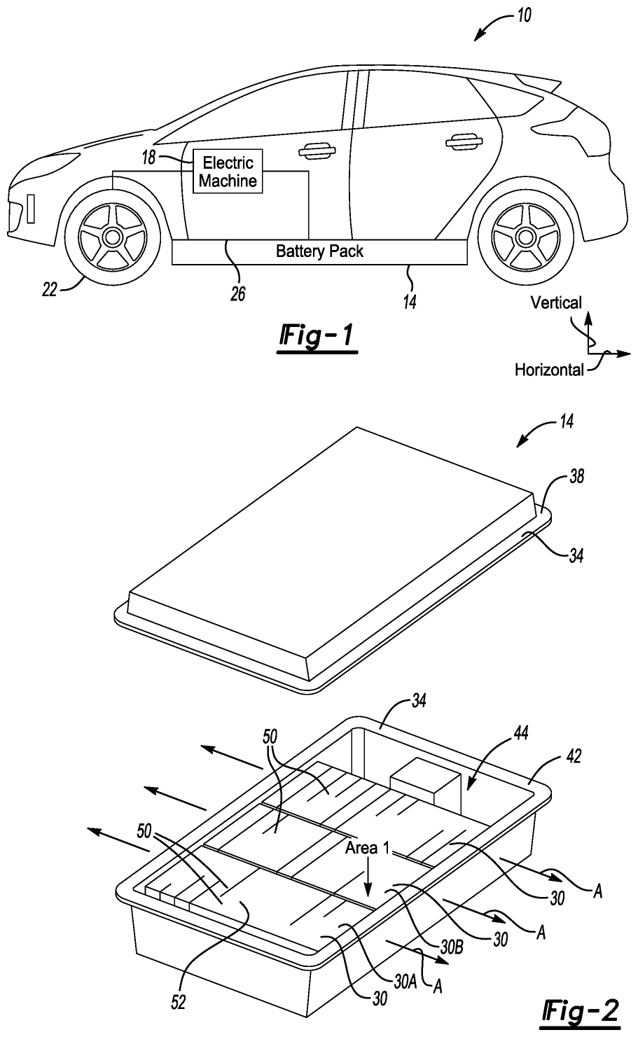

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

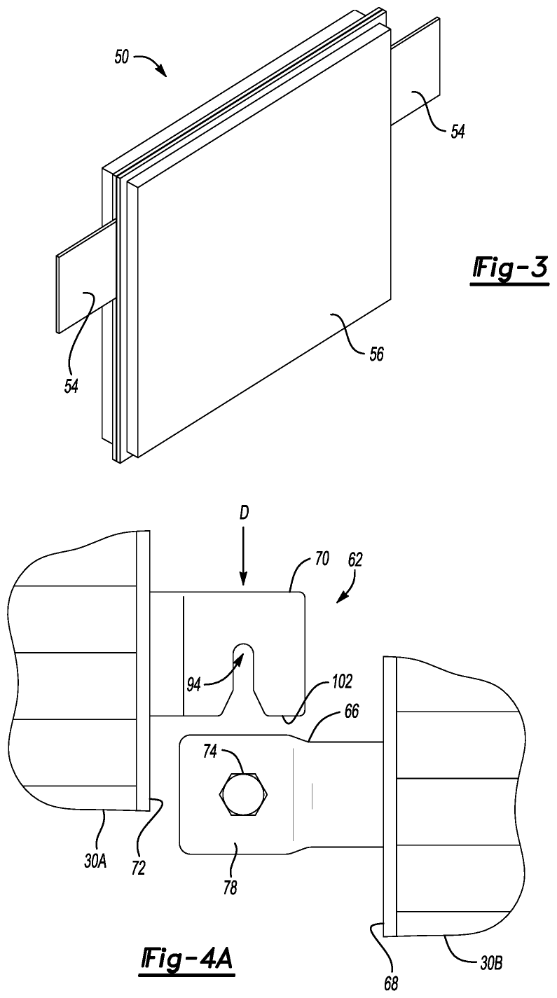

With reference now to FIGS. 2 and 3, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) stacked side-by-side relative to each along a respective cell stack axis A. In this example, the axes A of the cell stacks 30 and the cross-members 46 are parallel to each other and extend longitudinally in a cross-vehicle direction.

The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure.

Each of the example battery cells 50 includes a pair of tab terminals 54 extending from case 58. Within a given one of the cell stacks 30, the individual battery cells 50 can be electrically connected together. To provide these electrical connections, the tab terminals 54 of the battery cells 50 can be connected to the tab terminals 54 of other battery cells 50.

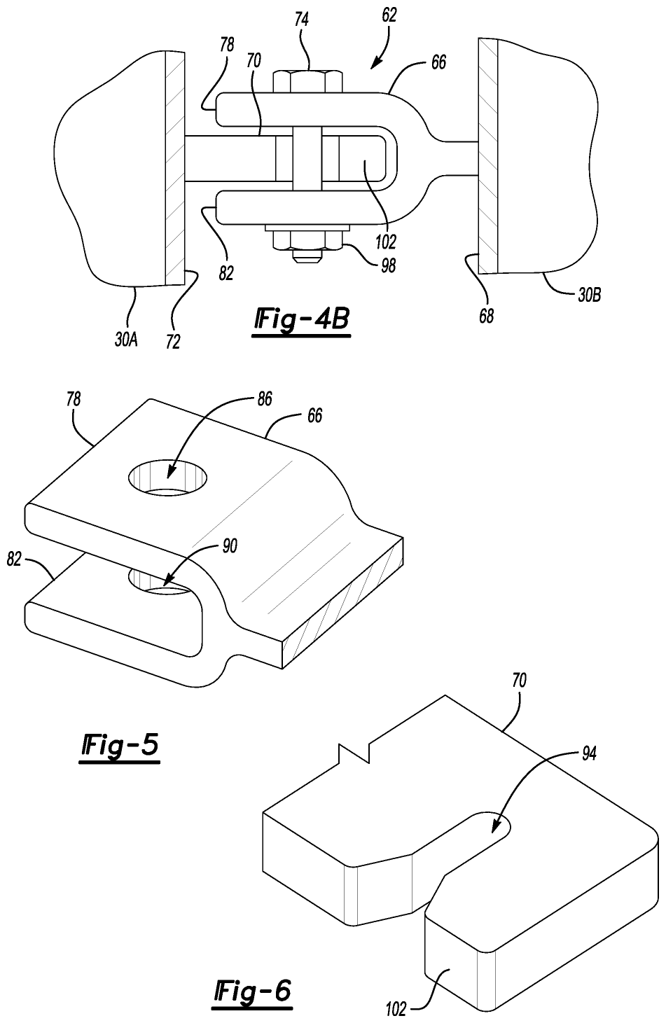

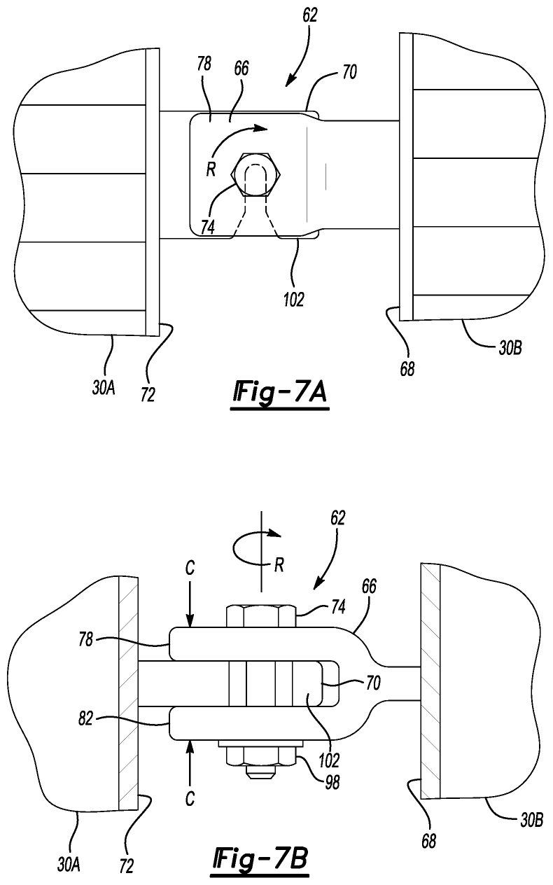

In this example, the battery pack 14 also electrically connects together the cell stacks 30. For example, with reference now to FIGS. 4A-7B and continued reference to FIGS. 2 and 3, a plurality of electrical connection systems 62 are included within the battery pack 14 to electrically connect the cell stack 30A to the cell stack 30B.

In other examples, the electrical connection system 62 could be utilized to electrically connect the cell stacks 30 to other components of the battery pack 14, such as a busbar module. In still other examples, components other than cell stacks 30 are electrically connected together with the electrical connection system 62.

The electrical connection system 62 could be used, for example, to electrically connect together components outside of the battery pack 14. Thus, although described as electrically connecting together cell stacks 30A and 30B, the electrical connection systems 62 of this disclosure are not, unless otherwise indicated, limited to electrically connecting together cell stacks 30.

In the exemplary embodiment, the electrical connection system 62 includes a clamping electrical contact 66 extending from a busbar 68 of the cell stack 30B, a clamped electrical contact 70 extending from a busbar 72 of the cell stack 30A, and a mechanical fastener 74. The busbar 68 is electrically connected to a battery terminal of a cell 50 within the cell stack 30B. The busbar 72 is electrically connected to a battery terminal of a cell 50 within the cell stack 30A.

The clamping electrical contact 66 has a first flange 78 spaced a distance from a second flange 82, which gives the clamping electrical contact 66 a C-shape when viewed from the side (see FIGS. 4B, 5, 7B).

The first flange 78 includes an aperture 86. The second flange 82 includes an aperture 90. The clamped electrical contact 70 includes a slot 94.

The mechanical fastener 76 is secured to clamp the clamped electrical contact 70 between the first flange 78 and the second flange 82 of the clamping electrical contact 66. The mechanical fastener 74 extends through the aperture 86, the slot 94, and the aperture 90 when securing the clamped electrical contact 70 between the first flange 78 of the clamping electrical contact 66 and the second flange 82 of the clamping electrical contact 66.

In the exemplary embodiment, a weld nut 98 is secured to the second flange 82 just below the aperture 90. The mechanical fastener 74 is a threaded mechanical fastener that threadably engaged the weld nut 98 during the securing.

Although demonstrated in this example as a mechanical fastener that is threadably secured, mechanical fasteners of other types, such as rivets, could be utilized to secure the clamped electrical contact 70 between the first flange 78 of the clamping electrical contact and the second flange 82 of the clamping electrical contact.

During securing of the electrical connection system 62, the mechanical fastener 74 can be positioned within the aperture 86 of the first flange 78 and the aperture 90 of the second flange 82 as shown in FIGS. 4A and 4B. The mechanical fastener 74 can loosely engage the weld nut 98 at this time.

Next, the clamped electrical contact 70 slides in the direction D (FIG. 4A) into position between the first flange 78 and the second flange 82. As the clamped electrical contact 70 slides in the direction D, the mechanical fastener 74 is received within the slot 94.

The slot 94 opens to an outer side 102 of the clamped electrical contact 70. Approaching the outer side 102, the slot 94 tapers or flares out to increase an effective opening size of the slot 94. The flaring and tapering can facilitate positioning the mechanical fastener 74 within the slot 94 as the clamped electrical contact 70 is moved in the direction D relative to the clamping electrical contact 66.

After the mechanical fastener 74 is disposed within the slot 94 and the clamped electrical contact 70 is disposed between the first flange 78 and the second flange 82 of the clamping electrical contact 66, the mechanical fastener 74 is rotated in a direction R as shown in FIGS. 7A and 7B. This moves the first flange 78 and the second flange 82 in the direction C to clamp the clamped electrical contact 70 between the first flange 78 and the second flange 82 of the clamping electrical contact 66.

Rotation of the mechanical fastener 74 secures the electrical connection system 62 so that cell stack 30 is electrically coupled to another cell stack 30 within the battery pack 14. Notably, since the electrical connection system 62 is secured utilizing a mechanical fastener 74 and a threaded joint, the electrical connection system 62 can be unsecured with relatively little disruption. Unsecuring the electrical connection system 62 involves unscrewing the mechanical fastener 74 from the weld nut 98.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A electrical connection system for a traction battery pack, comprising:
a clamping electrical contact having a first flange and a second flange;
a clamped electrical contact; and
a mechanical fastener that is secured to clamp the clamped electrical contact between the first flange of the clamping electrical contact and the second flange of the clamping electrical contact.

2. The electrical connection system of claim 1, wherein the clamping electrical contact extends from a first busbar, and the clamped electrical contact extends from a second busbar.

3. The electrical connection system of claim 2, wherein the first busbar is electrically connected to a first battery, and the second busbar is electrically connected to a second battery.

4. The electrical connection system of claim 3, wherein the first battery is within a first cell stack and the second battery is within a different, second cell stack.

5. The electrical connection system of claim 1, wherein the clamping electrical contact is C-shaped.

6. The electrical connection system of claim 1, wherein, when the mechanical fastener is secured, the mechanical fastener extends through an aperture in the first flange, and aperture in the second flange, and an aperture in the clamped electrical contact.

7. The electrical connection system of claim 6, wherein the aperture in the clamped electrical contact is a slot that opens to an outer side of the clamped electrical contact.

8. The electrical connection system of claim 7, wherein the slot is tapered moving toward the outer side of the clamped electrical contact.

9. The electrical connection system of claim 1, further comprising a weld nut secured to the second flange, wherein, when the mechanical fastener is secured, the mechanical fastener threadably engages the weld nut.

10. The electrical connection system of claim 1, wherein the clamped electrical contact and the clamping electrical contact are within a traction battery pack.

11. A method of electrically connecting components, comprising:
positioning a clamped electrical contact between a first flange of a clamping electrical contact and a second flange of the clamping electrical contact;
securing a mechanical fastener; and
during the securing, clamping a clamped electrical contact between a first flange of the clamping electrical contact and a second flange of the clamping electrical contact.

12. The method of claim 11, wherein, during the securing, the mechanical fastener extends through an aperture in the first flange, and aperture in the second flange, and an aperture in the clamped electrical contact.

13. The method of claim 12, wherein the aperture in the clamped electrical contact is a slot that opens to an outer side of the clamped electrical contact.

14. The method of claim 13, wherein the slot is flared moving toward an outer side of the clamped electrical contact.

15. The method of claim 11, further comprising a weld nut secured to the second flange, wherein, when the mechanical fastener is secured, the mechanical fastener threadably engages the weld nut.

16. The method of claim 11, wherein the clamping electrical contact extends from a first busbar, and the clamped electrical contact extends from a second busbar.

17. The method of claim 16, wherein the first busbar is electrically connected to a first battery, and the second busbar is electrically connected to a second battery.

18. The method of claim 17, wherein the first battery is within a first cell stack and the second battery is within a different, second cell stack.
